(19) United States
(12) Patent Application Publication
(10) Pub. No.: US 2025/0337042 A1
(43) Pub. Date: Oct. 30, 2025

(54) ELECTRICITY STORAGE DEVICE AND VEHICLE

(71) Applicant: TOYOTA JIDOSHA KABUSHIKI KAISHA, Toyota-shi (JP)

(72) Inventors: Akio UOTANI, Nagoya-shi (JP); Dexu ZHANG, Mishima-shi (JP); Yoshinobu KUROYAMA, Aichi-ken (JP); Daisuke KAMESAKI, Okazaki-shi (JP); Seigo FUJISHIMA, Miyoshi-shi (JP); Yuki TAKAHASHI, Miyoshi-shi (JP)

(73) Assignee: TOYOTA JIDOSHA KABUSHIKI KAISHA, Toyota-shi (JP)

(21) Appl. No.: 19/173,932

(22) Filed: Apr. 9, 2025

(30) Foreign Application Priority Data
Apr. 24, 2024 (JP) 2024-070703

(51) Int. Cl. H01M 10/6556; H01M 10/625; H01M 50/209; H01M 50/249; H01M 50/289; H01M 50/367

(52) U.S. Cl. CPC H01M 10/6556; H01M 10/625; H01M 50/209; H01M 50/249; H01M 50/289; H01M 50/367

(57) ABSTRACT

An electricity storage device includes a plurality of electricity storage stacks and a housing case that houses the electricity storage stacks. The housing case includes a top plate part that is located on an upper side of the electricity storage stacks and has an uneven shape, and demarcation members that demarcate regions where the electricity storage stacks are respectively disposed. The top plate part includes protruding portions that protrude upward and depressed portions that are depressed downward. The demarcation members are each disposed between the electricity storage stacks that lie next to each other. Flow passages through which a gas discharged from the electricity storage stacks flows are provided inside the demarcation members. The demarcation members are in contact with the depressed portion.

### CROSS-REFERENCE TO RELATED APPLICATION

This application claims priority to Japanese Patent Application No. 2024-070703 filed on Apr. 24, 2024, incorporated herein by reference in its entirety.

### BACKGROUND

### 1. Technical Field

This disclosure relates to an electricity storage device and a vehicle including this electricity storage device.

### 2. Description of Related Art

As a conventional electricity storage device, International Publication No. WO 2020/134054 discloses a structure in which demarcation members for demarcating regions where a plurality of electricity storage stacks is respectively disposed are formed by hollow members, and hollow parts of these hollow members are used as smoke exhaust paths. Each hollow member is provided with a plurality of through-holes for introducing a gas discharged from the electricity storage device.

### SUMMARY

The temperature of the gas discharged from the electricity storage device is considerably high, and when the gas flows through the smoke exhaust path, the temperature of the demarcation member in which that smoke exhaust path is provided also becomes high. The demarcation member is disposed between two electricity storage devices that lie next to each other. Therefore, when no measure is taken and the temperature of the demarcation member becomes high, heat is transferred to the electricity storage devices located next to the demarcation member, which can lead to a plurality of electricity storage devices heating up sequentially.

This disclosure has been made in view of the above-described problem, and an object of this disclosure is to provide an electricity storage device that, when a gas is discharged from one electricity storage device of two electricity storage devices lying next to each other, can mitigate heating up of the other electricity storage device of the two electricity storage devices lying next to each other, and a vehicle.

An electricity storage device based on this disclosure includes a plurality of electricity storage stacks and a housing case that houses the electricity storage stacks. The housing case includes a top plate part that is located on the upper side of the electricity storage stacks and has an uneven shape, and a demarcation member that demarcates regions where the electricity storage stacks are respectively disposed. The top plate part includes a protruding portion that protrudes upward and a depressed portion that is depressed downward. A flow passage through which a gas discharged from the electricity storage stacks flows is provided inside the demarcation member. The demarcation member is in contact with the depressed portion.

According to this configuration, when a gas is discharged from the electricity storage stacks, as the demarcation member in which the flow passage for a gas to flow is provided is in contact with the top plate part of the housing case, the heat of the gas flowing through the flow passage can be transferred to the top plate part through the demarcation member. Since the top plate part has an uneven shape, heat dissipation from the top plate part improves and the heat can be effectively released to the outside of the housing case. As a result, when a gas is discharged from one electricity storage device of two electricity storage devices lying next to each other, heat transfer to the other electricity storage device of the two electricity storage devices lying next to each other can be mitigated, and thus heating up of the other electricity storage device can be mitigated.

In the electricity storage device based on this disclosure described above, the protruding portion and the depressed portion may be provided so as to extend along a direction intersecting an up-down direction.

According to this configuration, the protruding portion and the depressed portion extend along a predetermined direction, which can increase the surface area of the top plate part. Thus, heat dissipation from the top plate part can be further enhanced.

A vehicle based on this disclosure includes the above-described electricity storage device and a vehicle body. The protruding portion is in contact with part of the vehicle body.

According to this configuration, heat transferred from the demarcation member to the top plate part can be transferred to the vehicle body through the protruding portion, and thus the heat can be dissipated from the vehicle body as well.

This disclosure can provide an electricity storage device that, when a gas is discharged from one electricity storage device of two electricity storage devices lying next to each other, can mitigate heating up of the other electricity storage device of the two electricity storage devices lying next to each other, and a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a vehicle according to Embodiment 1;

FIG. 2 is a schematic exploded perspective view of the electricity storage device according to Embodiment 1;

FIG. 3 is a schematic sectional view showing the electricity storage device according to Embodiment 1 as installed;

FIG. 4 is a schematic exploded perspective view of an electricity storage device according to Embodiment 2; and

FIG. 5 is a schematic exploded perspective view of an electricity storage device according to Embodiment 3.

### DETAILED DESCRIPTION OF EMBODIMENTS

Embodiments of this disclosure will be described in detail below with reference to the drawings. In the embodiments to be shown below, parts that are the same or shared will be denoted by the same reference sign in the drawings and description thereof will not be repeated.

### Embodiment 1

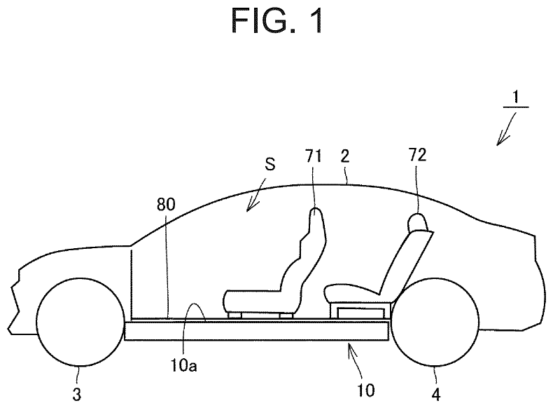

FIG. 1 is a schematic view showing a vehicle according to Embodiment 1. A vehicle 1 according to Embodiment 1 will be described with reference to FIG. 1.

The vehicle 1 is a hybrid electric vehicle that can travel using motive power of at least either a motor or an engine, or an electrified vehicle that travels on drive power obtained by electric energy.

As shown in FIG. 1, the vehicle 1 includes a vehicle main body (vehicle body) 2, front wheels 3, rear wheels 4, an electricity storage device 10, a pair of front seats 71, a rear seat 72, and a floor carpet 80. The vehicle main body 2 includes a boarding pace S. The boarding space S is located above the floor carpet 80. In the boarding space S, the front seats 71 and the rear seat 72 are disposed. The front seats 71 are disposed side by side at an interval in a width direction of the vehicle. The rear seat 72 is disposed behind the front seats 71. The rear seat 72 extends in the width direction of the vehicle.

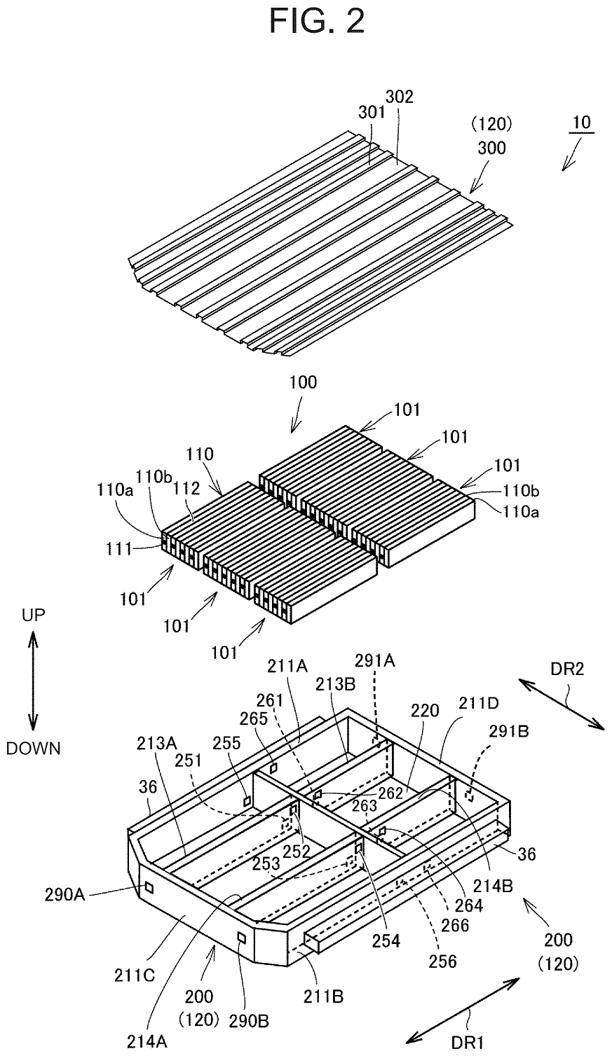

The electricity storage device 10 is disposed under the boarding space S. The electricity storage device 10 is fixed on the vehicle main body 2. The electricity storage device 10 has an upper surface 10a. The upper surface 10a functions also as a floor member that defines a cabin of the vehicle. The floor carpet 80 is located above the upper surface 10a. A heat insulation member may be disposed in a gap between the floor carpet 80 and the upper surface 10a. The floor carpet 80 may be disposed so as to cover a cross member 9 (see FIG. 2), to be described later, from above.

FIG. 2 is a schematic exploded perspective view of the electricity storage device according to Embodiment 1. Referring to FIG. 2, details of the electricity storage device 10 according to Embodiment 1 will be described.

As shown in FIG. 2, the electricity storage device 10 includes an electricity storage module 100 and a housing case 120. The electricity storage module 100 includes a plurality of electricity storage stacks 101 and is housed inside the housing case 120.

The electricity storage module 100 includes a plurality of electricity storage stacks 101. The electricity storage stacks 101 are disposed in lines and rows inside the housing case 120. When a first direction (DR1) is a row direction and a second direction (DR2) is a line direction, the electricity storage stacks 101 are disposed in, for example, three lines and two rows. In an installed state where the electricity storage device 10 is installed in the vehicle main body 2, the first direction is, for example, parallel to a front-rear direction of the vehicle 1. The second direction is orthogonal to the first direction. In the installed state, the second direction is parallel to a right-left direction of the vehicle 1. The electricity storage stacks 101 are electrically connected in series.

Each electricity storage stack 101 includes a plurality of unit cells 110. In each electricity storage stack 101, the unit cells 110 are arranged in the second direction. The unit cells 110 are electrically connected in series.

The unit cell 110 has an elongated shape with a longitudinal direction oriented in the first direction. The unit cell 110 has a flat rectangular parallelepiped shape with a thickness oriented in the second direction.

The unit cell 110 includes a casing 112, and a single electrode body or a plurality of electrode bodies is housed inside the casing 112.

When a single electrode body is housed inside the casing 112, this electrode body has a shape extending in the longitudinal direction. The electrode body may be a laminated electrode body into which a negative electrode sheet, a separator, and a positive electrode sheet are laminated, or may be a rolled electrode body into which a negative electrode sheet, a separator, and a positive electrode sheet are rolled.

When a plurality of electrode bodies is housed inside the casing 112, the electrode bodies are disposed side by side in the longitudinal direction and connected in series. Also in this case, the electrode bodies may be laminated electrode bodies or may be rolled electrode bodies.

The unit cell 110 is a secondary battery, such as a nickel-metal hydride battery or a lithium-ion battery. The unit cell 110 may be one that uses a liquid electrolyte or may be one that uses a solid electrolyte. The unit cell 110 may be a chargeable and dischargeable capacitor.

The casing 112 is made of, for example, a metal material, such as aluminum. The casing 112 includes a first end face 110a and a second end face 110b that are arranged in the first direction, and an exhaust valve 111. The exhaust valve 111 is formed in the first end face 110a. When an internal pressure of the casing 112 exceeds a predetermined value, the exhaust valve 111 opens to discharge a gas inside the casing 112 to an outside of the 25 casing 112.

In each electricity storage stack 101, the unit cells 110 are arranged in the second direction such that the exhaust valves 111 are located alternately on one side in the first direction and on the other side in the first direction. That is, the unit cells 110 are arranged such that the first end faces 110a and the second end faces 110b alternate each other in the second direction on each of the one side and the other side in the first direction. The housing case 120 includes an upper member 300 and a lower case 200. In this embodiment, the upper member 300 is formed by a plate-like member and functions as a top plate part. The upper member 300 closes an opening of the lower case 200. The upper member 300 is located on an upper side of the electricity storage stacks 101 and has an uneven shape.

The upper member 300 has a plurality of protruding portions 301 and a plurality of depressed portions 302. The protruding portions 301 and the depressed portions 302 are provided so as to extend along a direction intersecting an up-down direction. Specifically, the protruding portions 301 and the depressed portions 302 extend along the first direction.

The protruding portions 301 and the depressed portions 302 are provided so as to alternate each other in the second direction. The protruding portions 301 protrude upward and the depressed portions 302 are depressed downward. The protruding portions 301 and the depressed portions 302 form the uneven shape of the upper member 300.

The upper member 300 is not limited to a plate-like shape and may instead have a substantially box shape that opens downward. In this case, the upper member 300 includes a top plate part and a peripheral wall part that extends downward from an outer peripheral edge portion of the top plate part, and the top plate part has an uneven shape.

The lower case 200 has a substantially box shape that opens upward. The lower case 200 includes a bottom plate 220, a pair of side wall parts 211A, 211B, a pair of end wall parts 211C, 211D, a plurality of demarcation members 213A, 213B, 214A, 214B, and a partition member 215.

The bottom plate 220 is disposed facing the upper member 300 in the up-down direction. The side wall parts 211A, 211B and the end wall parts 211C, 211D rise upward from a peripheral edge of the bottom plate 220 and constitute a peripheral wall part of the lower case 200.

The lower case 200 includes a main body part 35 and fixed parts 36. The main body part 35 is composed of the peripheral wall part and the bottom plate 220. The fixed parts 36 are provided on both side faces of the main body part 35 in the second direction. The fixed parts 36 extend along the first direction. As will be described later, the fixed parts 36 are parts that are fixed to the vehicle main body 2.

The side wall parts 211A, 211B are arranged in the second direction. The side wall parts 211A, 211B extend along the first direction. The end wall parts 211C, 211D are arranged in the first direction. The end wall parts 211C, 211D extend along the second direction.

The partition member 215 is formed on an upper surface of the bottom plate 220 so as to extend in the second direction. The partition member 215 divides a space inside the housing case 120 in the first direction. The partition member 215 may be formed to be hollow.

Each of the demarcation members 213A, 213B, 214A, 214B is disposed between two electricity storage stacks 101 that lie next to each other in the second direction.

The demarcation members 213A, 214A are disposed in a space on the one side in the first direction inside the housing case 120 that is partitioned by the partition member 215.

The demarcation members 213A, 214A are disposed on the one side in the first direction, between the side wall parts 211A, 211B. The demarcation members 213A, 214A are disposed away from the side wall parts 211A, 211B and disposed at an interval in the second direction.

The demarcation members 213A, 214A divide, in the second direction, a space inside the housing case 120 that is located on the one side in the first direction from the partition member 215. Specifically, the demarcation members 213A, 214A divide the space on the one side in the first direction inside the housing case 120 into three in the second direction. In the space inside the housing case 120 located on the one side in the first direction, the electricity storage stacks 101 are respectively disposed in the three regions demarcated by the demarcation members 213A, 214A.

The demarcation members 213B, 214B are disposed in a space on the other side in the first direction inside the housing case 120 that is partitioned by the partition member 215.

The demarcation members 213B, 214B are disposed on the other side in the first direction, between the side wall parts 211A, 211B. The demarcation members 213B, 214B are disposed away from the side wall parts 211A, 211B and disposed at an interval in the second direction.

The demarcation members 213B, 214B divide, in the second direction, a space inside the housing case 120 that is located on the other side in the first direction from the partition member 215. Specifically, the demarcation members 213B, 214B divide the space on the other side in the first direction inside the housing case 120 into three in the second direction. In the space inside the housing case 120 located on the other side in the first direction, the electricity storage stacks 101 are respectively disposed in the three regions demarcated by the demarcation members 213B, 214B.

Inside the side wall parts 211A, 211B, the end wall parts 211C, 211D, and the demarcation members 213A, 213B, 214A, 214B, flow passages through which a gas can flow are provided. The end wall part 211C is provided with discharge ports 290A, 290B for discharging a gas to an outside of the housing case 120, and the end wall part 211D is provided with discharge ports 291A, 291B for discharging a gas to the outside of the housing case 120.

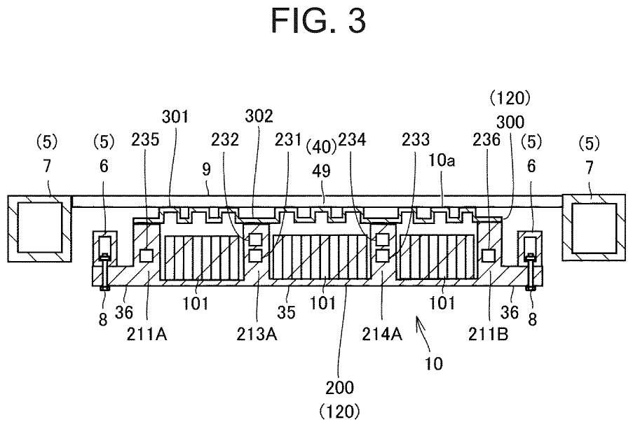

The side wall part 211A is provided with side wall part openings 255, 265. The side wall part opening 255 communicates with the discharge ports 290A, 290B through a flow passage 235 (see FIG. 3) provided inside the side wall part 211A. The side wall part opening 255 communicates with the discharge ports 291A, 291B through the flow passage (not shown) provided inside the side wall part 211A.

The demarcation member 213A is provided with openings 251, 252. The opening 251 is provided in a principal surface of the demarcation member 213A that is located on one side in the second direction. The opening 252 is provided in a principal surface of the demarcation member 213A that is located on the other side in the second direction. The openings 251, 252 communicate with the discharge ports 290A, 290B through flow passages 231, 232 (see FIG. 3) provided inside the demarcation member 213A.

The demarcation member 214A is provided with openings 253, 254. The opening 253 is provided in a principal surface of the demarcation member 214A that is located on the one side in the second direction. The opening 254 is provided in a principal surface of the demarcation member 214A that is located on the other side in the second direction. The openings 253, 254 communicate with the discharge ports 290A, 290B through flow passages 233, 234 (see FIG. 3) provided inside the demarcation member 214A.

The demarcation member 213B is provided with openings 261, 262. The opening 261 is provided in a principal surface of the demarcation member 213B that is located on the one side in the second direction. The opening 262 is provided in a principal surface of the demarcation member 213B that is located on the other side in the second direction. The openings 261, 262 communicate with the discharge ports 291A, 291B through the flow passage (not shown) provided inside the demarcation member 213B.

The demarcation member 214B is provided with openings 263, 264. The opening 263 is provided in a principal surface of the demarcation member 214B that is located on the one side in the second direction. The opening 264 is provided in a principal surface of the demarcation member 214B that is located on the other side in the second direction. The openings 263, 264 communicate with the discharge ports 291A, 291B through the flow passage (not shown) provided inside the demarcation member 214B.

The side wall part 211B is provided with side wall part openings 256, 266. The side wall part opening 256 communicates with the discharge ports 290A, 290B through a flow passage 236 (see FIG. 3) provided inside the side wall part 211B. The side wall part opening 266 communicates with the discharge ports 291A, 291B through the flow passage (not shown) provided inside the side wall part 211A.

The side wall part openings 255, 256, 265, 266 and the openings 251 to 254 and 261 to 264 are each open toward one of the regions where the electricity storage stacks 101 are disposed. When a gas is discharged from one of the electricity storage stacks 101, the gas is introduced into one of the above-described flow passages from one of the above- described side wall part openings and the above-described openings that opens toward the region where the electricity storage stack 101 discharging the gas is disposed, and the gas is discharged to the outside of the housing case 120 from the discharge ports 290A, 290B or the discharge ports 291A, 291B.

FIG. 3 is a schematic sectional view showing the electricity storage device according to Embodiment 1 as installed. The electricity storage device 10 as installed will be described with reference to FIG. 3.

As shown in FIG. 3, the vehicle main body 2 includes a framework member 5. The framework member 5 includes a pair of side members 6 and a pair of side sills 7. The side sills 7 are disposed on both end sides in the width direction of the vehicle 1. The side members 6 are disposed on an inner side of, and apart from, the side sills 7. The side members 6 and the side sills 7 extend along the front-rear direction of the vehicle 1.

The side members 6 are spaced apart in the width direction of the vehicle 1. In a gap between the side members 6, the main body part 35 of the electricity storage device 10 is disposed. Between the main body part 35 and each side member 6, a clearance is provided. Thus, even when the vehicle 1 experiences a lateral collision, input of impact into the electricity storage device 10 can be mitigated.

The fixed parts 36 are provided on both side surfaces of the main body part 35 in the width direction of the vehicle 1. The fixed parts 36 are fixed on the side members 6 with fastening members 8.

The framework member 5 further includes the cross member 9. The cross member 9 is provided on an upper side of the electricity storage device 10 so as to straddle it from one side sill 7 to the other side sill 7. The electricity storage device 10 is fastened and fixed on the cross member 9.

While the above description has been given by illustrating the case where the framework member 5 includes the side members 6 and the side sills 7, this disclosure is not limited thereto. The side sills 7 may also fulfill the function of the side members 6. In this case, the side members 6 can be omitted, and the fixed parts 36 may be fixed on the side sills 7.

In the housing case 120, an upper surface of each of the demarcation members 213A, 213B, 214A, 214B is in contact with the depressed portion 302 of the upper member 300. Upper surfaces of the side wall parts 211A, 211B are also in contact with the depressed portions 302.

In the demarcation members 213A, 213B, 214A, 214B and the side wall parts 211A, 211B, the flow passages through which a gas discharged from the electricity storage stacks 101 can flow are provided as described above, and when a gas flows through these flow passages, the temperatures of the demarcation members and the side wall parts having these flow passages rise.

Meanwhile, as the demarcation members 213A, 213B, 214A, 214B and the side wall parts 211A, 211B are in contact with the depressed portions 302, the heat of the gas flowing through the flow passages can be transferred to the upper member 300 through the demarcation member and the side wall part. Since the upper member 300 has an uneven shape, heat dissipation from the upper member 300 improves and the heat can be effectively released to the outside of the housing case 120. As a result, when a gas is discharged from one electricity storage stack of the two electricity storage stacks 101 lying next to each other, heat transfer to the other electricity storage stack of the two electricity storage stacks 101 lying next to each other can be mitigated, and thus heating up of the other electricity storage stack can be mitigated.

Further, the protruding portions 301 of the upper member 300 are in contact with the cross member 9 that is a part of the vehicle main body 2. Therefore, the heat transferred from the demarcation member and/or the side wall part to the upper member 300 can be transferred to the vehicle main body 2 though the protruding portions, and thus the heat can be dissipated toward the outside from the vehicle main body 2 as well.

In addition, the protruding portions 301 and the depressed portions 302 extend along a direction intersecting the up-down direction, which can increase the surface area of the upper member 300. Thus, heat dissipation from the upper member 300 can be further enhanced.

In the case where the protruding portions 301 and the depressed portions 302 extend along a direction parallel to the front-rear direction of the vehicle, outside air flows easily through insides of the depressed portions 302 during travel of the vehicle 1, which can further enhance heat dissipation from the upper member 300.

Moreover, since the upper member 300 has an uneven shape, the rigidity of the upper member 300 can be enhanced.

The flow passage through which a gas flows may be provided in the partition member 215, and an upper surface of the partition member 215 may be in contact with the depressed portion 302. Also in this case, heat from a gas flowing through the inside of the partition member 215 can be transferred to the upper member 300.

### Embodiment 2

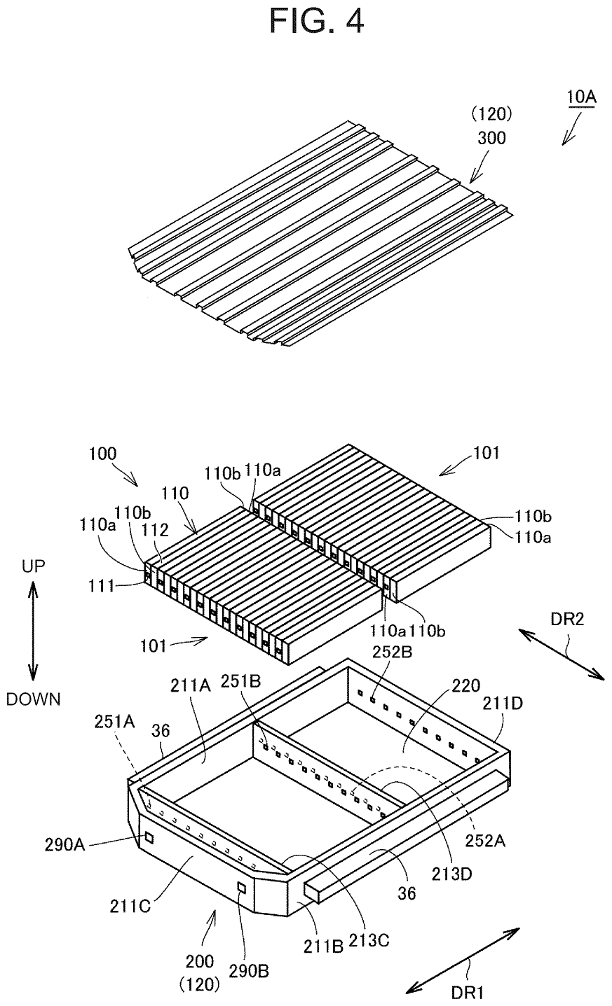

FIG. 4 is a schematic exploded perspective view of an electricity storage device according to Embodiment 2. An electricity storage device 10A according to Embodiment 2 will be described with reference to FIG. 4.

As shown in FIG. 4, compared with the electricity storage device 10 according to Embodiment 1, the electricity storage device 10A according to Embodiment 2 differs in the configuration of the housing case 120 and the number of the electricity storage stacks 101. The other components are almost the same.

In the electricity storage device 10A according to Embodiment 2, two electricity storage stacks 101 are disposed at an interval in the first direction. The lower case 200 includes two demarcation members 213C, 213D. Flow passages through which a gas can flow are provided inside the demarcation members 213C, 213D.

The two demarcation members 213C, 213D are disposed at an interval in the first direction. The demarcation member 213C is located on the one side in the first direction relative to the demarcation member 213D. The demarcation member 213D is disposed at a substantially central portion of the bottom plate 220 in the first direction. The demarcation members 213C, 213D extend along the second direction. The two demarcation members 213C, 213D are disposed on the bottom plate 220 and divide the space inside the housing case 120 into three in the second direction.

The demarcation member 213C is provided with a plurality of openings 251A. The demarcation member 213D is provided with a plurality of openings 251B and a plurality of openings 252A. The end wall part 211D is provided with a plurality of openings 252B.

The openings 251A, 251B are open toward a region which is located between the demarcation member 213C and the demarcation member 213D and in which the electricity storage stack 101 is disposed. The openings 252A, 252B are open toward a region which is located between the demarcation member 213D and the end wall part 211D and in which the electricity storage stack 101 is disposed.

The openings 251A, 251B, 252A, 252B communicate with the discharge ports 290A, 290B through the flow passages provided inside the side wall parts 211A, 211B, the demarcation members 213C, 213D, and the end wall parts 211C, 211D. The openings 251A, 251B, 252A, 252B are disposed facing the exhaust valves 111 of the unit cells 110.

When a gas is discharged from one of the two electricity storage stacks 101, the gas is introduced into one of the above-described flow passages from one of the openings 251A, 251B, 252A, 252B that opens toward the region where the electricity storage stack 101 discharging the gas is disposed, and the gas is discharged from the discharge ports 290A, 290B or the discharge ports 291A, 291B to the outside of the housing case 120.

Also in this embodiment, the demarcation members 213C, 213D are in contact with the depressed portions 302 of the upper member 300. Thus, the electricity storage device 10A and the vehicle including the electricity storage device 10A according to Embodiment 2 can produce almost the same effects as the electricity storage device 10 and the vehicle 1 according to Embodiment 1.

In addition, since the openings 251A, 251B, 252A, 252B are disposed facing the exhaust valves 111 of the unit cells 110, a gas discharged from the exhaust valves 111 can be directly introduced into the flow passages.

### Embodiment 3

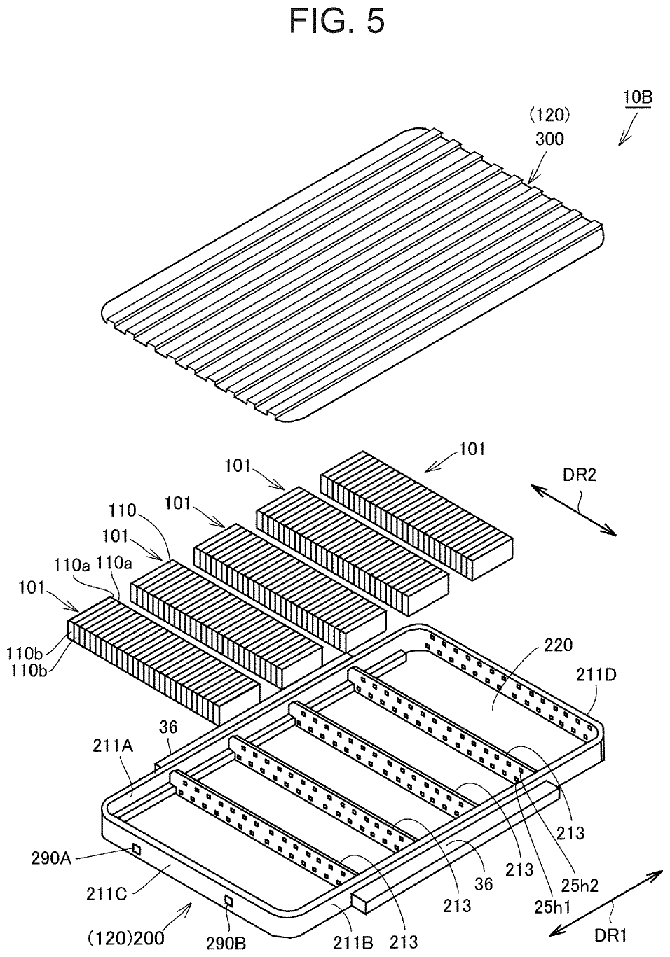

FIG. 5 is a schematic exploded perspective view of an electricity storage device according to Embodiment 3. An electricity storage device 10B according to Embodiment 3 will be described with reference to FIG. 5.

As shown in FIG. 5, compared with the electricity storage device 10A according to Embodiment 2, the electricity storage device 10B according to Embodiment 3 differs in the configuration of the housing case 120 and the number and arrangement of the electricity storage stacks 101. The other components are almost the same.

In the electricity storage device 10B according to Embodiment 3, the inside of the housing case 120 is divided into five regions by four demarcation members 213, and five electricity storage stacks 101 are disposed at intervals in the second direction. The demarcation members 213 are each disposed between the electricity storage stacks 101 that lie next to each other in the first direction. The number of the electricity storage stacks 101 is not limited to five and may be any number not smaller than two. The number of the demarcation members 213 can be set as appropriate according to the number of the electricity storage stacks 101.

In each electricity storage stack 101, the unit cells 110 included in the electricity storage stack 101 are arranged in the second direction such that the first end faces 110a of the unit cells 110 face the other side in the first direction. That is, in each electricity storage stack 101, all the exhaust valves 111 face the other side in the first direction. The exhaust valves 111 are located side by side in the second direction in a state of being staggered in the up-down direction.

Each demarcation member 213 is provided with a plurality of openings 25h1, 25h2 that opens toward a region located on the one side in the first direction relative to the demarcation member. The end wall part 211D is also provided with a plurality of openings 25h1, 25h2 that opens toward a region located on the one side in the first direction relative to the end wall part 211D. The openings 25h1, 25h2 are located side by side in the second direction in a state of being staggered in the up-down direction. The openings 25h1, 25h2 face the exhaust valves 111 included in the electricity storage stack 101 located on the one side in the first direction. Thus, a gas discharged from the exhaust valves 111 can be introduced from the openings 25h1, 25h2 directly into the demarcation member 213 or the end wall part 211D. The gas introduced into the demarcation member 213 or the end wall part 211D passes through the flow passage and is discharged from the discharge ports 290A, 290B.

Also in this embodiment, each of the demarcation members 213 is in contact with the depressed portion 302 of the upper member 300. Thus, the electricity storage device 10B and the vehicle according to Embodiment 3 can produce almost the same effects as the electricity storage device 10A and the vehicle according to Embodiment 2.

The embodiments disclosed this time are in every respect illustrative and not restrictive. The scope of the present disclosure is indicated by the claims and includes all changes within the meaning and the scope of equivalents of the claims.

What is claimed is:

1. An electricity storage device comprising:
a plurality of electricity storage stacks; and
a housing case that houses the electricity storage stacks, wherein:
the housing case includes a top plate part that is located on an upper side of the electricity storage stacks and has an uneven shape, and a demarcation member that demarcates regions where the electricity storage stacks are respectively disposed;
the top plate part includes a protruding portion that protrudes upward and a depressed portion that is depressed downward;
a flow passage through which a gas discharged from the electricity storage stacks flows is provided inside the demarcation member; and
the demarcation member is in contact with the depressed portion.

2. The electricity storage device according to claim 1, wherein the protruding portion and the depressed portion are provided so as to extend along a direction intersecting an up-down direction.

3. A vehicle comprising:
the electricity storage device according to claim 1; and
a vehicle body, wherein
the protruding portion is in contact with part of the vehicle body.
